(19) United States
(12) Patent Application Publication
(10) Pub. No.: US 2016/0281538 A1
(43) Pub. Date: Sep. 29, 2016

(54) Process to Remanufacture a Turbine Backplate

(71) Applicant: Caterpillar Inc., Peoria, IL (US)

(72) Inventors: Jeremiah Keltner, Galesburg, IL (US); Bryan Mills, Corinth, MS (US); Robert Sharp, Corinth, MS (US); Gregory Lambert, Corinth, MS (US); Roy Sorrell, Corinth, MS (US); Jacob Fabrizius, Corinth, MS (US)

(73) Assignee: Caterpillar Inc., Peoria, IL (US)

(21) Appl. No.: 14/665,256

(22) Filed: Mar. 23, 2015

(51) Int. Cl. F01D 25/24

(52) U.S. Cl. CPC F01D 25/24; F05D 2220/40; F05D 2230/10; F05D 2230/311; F05D 2230/312; F05D 2300/177; F05D 2300/44; F05D 2300/43

(57) ABSTRACT

A process of remanufacturing a backplate used in turbochargers is provided and includes using a mask or an anti-bonding agent and a thermal metal spray. The mask or anti-bonding agent protects the portions of the backplate from being sprayed. The thermal metal spray can be sprayed on a sealing surface of the backplate that is worn during use. Once the process is completed, the backplate can be inspected to ensure that it meets or exceeds the manufacturer's original specifications.

### TECHNICAL FIELD

The disclosure relates to a turbine backplate, and more specifically, relating to remanufacturing of the turbine backplate.

### BACKGROUND

Combustion engines such as diesel engines, gasoline engines, and gaseous fuel-powered engines are supplied with a mixture of air and fuel for combustion within the engine that generates a mechanical power output. In order to maximize the power output generated by this combustion process, the engine is often equipped with a divided exhaust manifold in fluid communication with a turbocharged air induction system.

The divided exhaust manifold increases engine power by helping to preserve exhaust pulse energy generated by the engine's combustion chambers. Preserving the exhaust pulse energy improves the turbocharger's operation, which results in a more efficient use of fuel. In addition, the turbocharged air induction system increases engine power by forcing more air into the combustion chambers than would otherwise be possible. This increased amount of air allows for enhanced fueling that further increases the power output generated by the engine.

However, during use and due to high operating temperatures, components of the turbocharger wear down and need to be replaced. One such component is the backplate and in particular, the sealing surface of the backplate, which can be damaged during use and thus, the backplate needs to be replaced or remanufactured.

U.S. Pat. No. 4,449,714 discloses a method for repairing turbine engine seals and a product manufactured in accordance with the method are provided. A worn or damaged honeycomb seal is removed from a backing plate together with a portion of the surface of the plate. The plate is restored to substantially its original thickness by a low pressure plasma spraying operation which may be followed by further machining to arrive at the required plate thickness. A new seal is then brazed thereon. The finished product will include the backing plate, a low pressure plasma sprayed coated surface, and a honeycomb seal brazed to the coated surface. However, the disclosed process does not provide a way to protect the remaining parts of the backplate from being subjected to the low pressure plasma spray.

Thus, there is a need for an improved process that provides protection to the remaining parts of backplate that are not subjected to the coating process and allow the backplate to be reused.

### SUMMARY

In one aspect, a method of remanufacturing a back plate of a turbocharger is disclosed and can include cleaning the backplate for a first time, protecting a portion of the backplate, other than a sealing surface from a thermal metal spray with a mask, machining the backplate for a first time, applying a metal to the sealing surface with a thermal metal spray, and machining the backplate for a second time.

In another aspect, a method of remanufacturing a backplate of a turbocharger is disclosed and can include cleaning the backplate for a first time, protecting a portion of the backplate other than a sealing surface from a thermal metal spray with an antibonding agent, machining the backplate for a first time, applying a metal to the sealing surface with a thermal metal spray, and machining the backplate for a second time.

### BRIEF DESCRIPTION OF THE DRAWINGS

FIG. 1 illustrates turbochargers having a backplate according to an aspect of the disclosure.

FIG. 2 illustrates the backplate according to an aspect of the disclosure.

FIG. 3 illustrates a masking mold for use in a remanufacturing process according to an aspect of the disclosure.

FIG. 4 illustrates a mask used in the remanufacturing process according to an aspect of the disclosure.

FIG. 5 illustrates the remanufacturing process according to an aspect of the disclosure.

### DETAILED DESCRIPTION

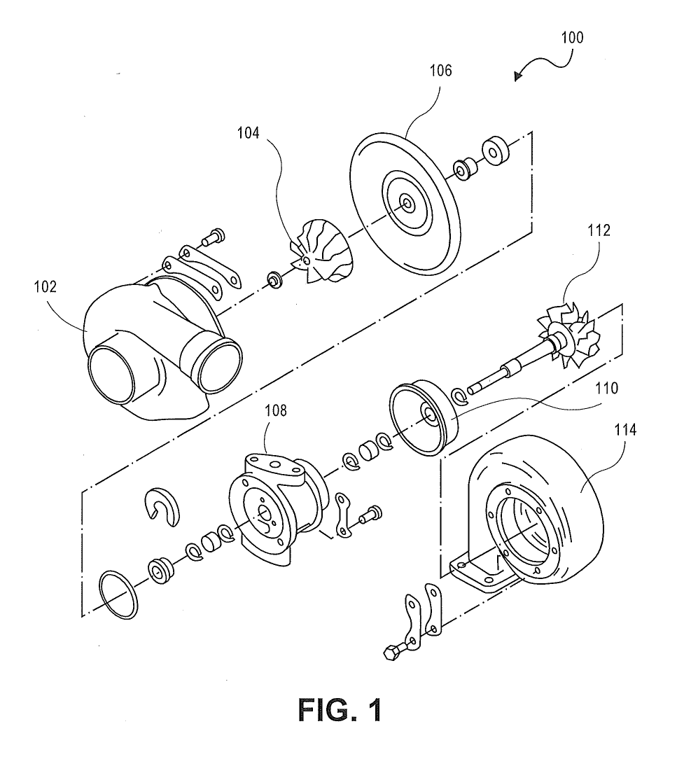

FIG. 1 illustrates turbochargers 100 having a backplate 106 according to an aspect of the disclosure. The turbochargers 100 main components include a compressor housing 102, a compressor wheel 104, the backplate 106, a central housing 108, a wheel shroud 110, a turbine wheel 112 and a turbine housing 114. The compressor housing 102 is typically made from aluminum and contains a volute that collects compressed air from the compressor wheel 104 and directs it to the engine. The compressor wheel 104 can function to pump air into the engine and is usually made of aluminum, either cast or forged milled billet. In operation, the compressor wheel 104 can pull air from a filter assembly (not shown) and then spins it at a high rate of speed into the compressor housing volute to produce pressure to feed the engine.

The backplate 106 can support the compressor housing 102 by being bolted thereto. The central housing 108 houses ball bearings and other components and the wheel shroud 110 houses the turbine wheel 112. The turbine wheel 112 converts exhaust energy (heat and pressure) into shaft power to drive the compressor (not shown) via the compressor wheel 104. Turbine wheels are usually made of Inconel or other high temperature alloys to allow them to perform in a temperature environment that regularly exceeds 1200° F. Because the turbine wheel 112 and the compressor wheel 104 are connected via the shaft, they both rotate at substantially the same speed. The turbine housing 114 collects exhaust gases from the engine and directs it to the turbine wheel 112. The turbine housing 114 can be made from iron or steel.

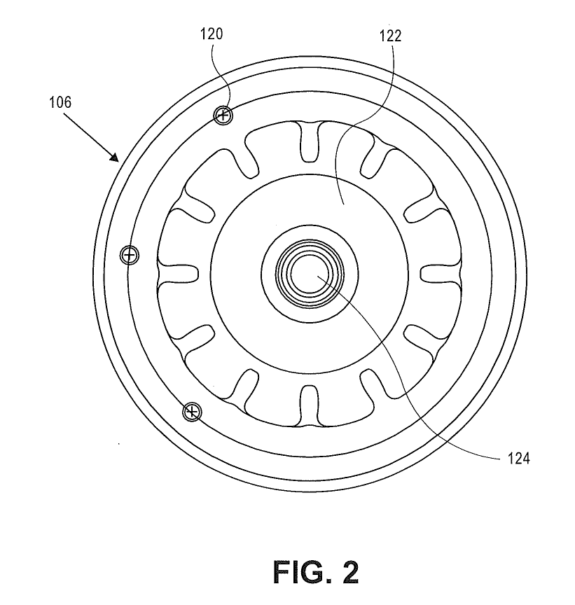

The backplate 106 further separates the compressor housing 102 from the central housing 108. Since the backplate 106 is separate from the compressor housing 102 and the central housing 108, the backplate 106 can be made of a different material including aluminum and various alloys. The backplate 106 provides a sealing surface 122 (FIG. 2) for a compressor side seal and prevents compressed air from entering the central housing 108. However, during use, the sealing surface 122 can deteriorate due to conditions in the turbochargers requiring replacement or remanufacturing.

FIG. 2 illustrates the backplate 106 according to an aspect of the disclosure. The backplate 106 includes a fastener receiving portion 120, the sealing surface 122, and a shaft receiving portion 124. The fastener receiving portion 120 is configured to receive a fastener, such as a screw, bolt and the like. The shaft receiving portion 124 is configured to receive the shaft of turbine wheel 112. The sealing surface 122 is the portion of the backplate 106 that wears out faster than other portions of the backplate.

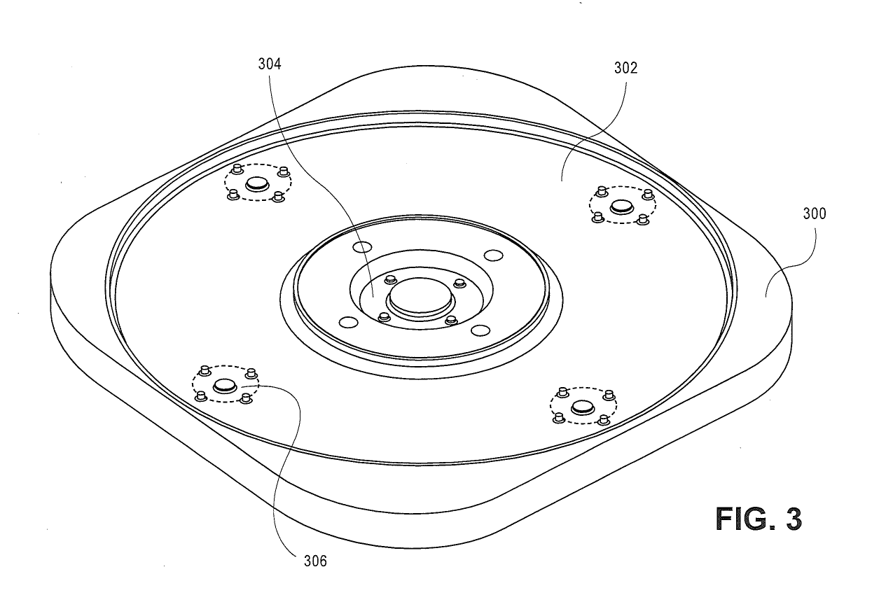

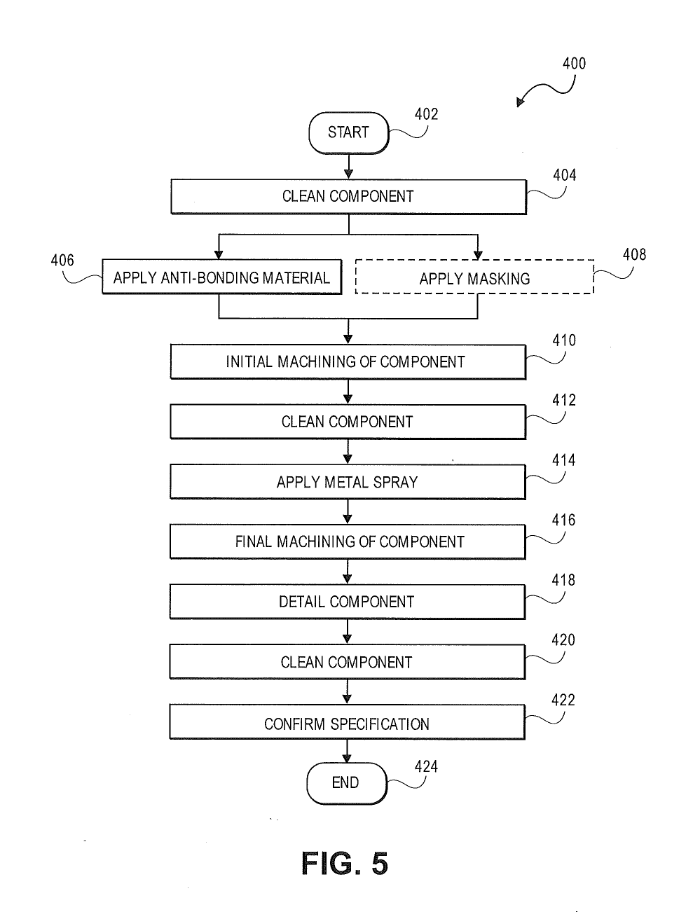

A method of remanufacturing the sealing surface 122 is discussed below (FIG. 5) and includes using a thermal metal spray process to add material to sealing surface. In order to protect the remaining portions of the backplate 106 during the thermal metal spray, a mold is created. FIG. 3 illustrates a masking mold 300 for use in a remanufacturing process according to an aspect of the disclosure. The masking mold can be made of steel, aluminum, or an alloy. The masking mold 300 includes a primary cover 302, which may be larger than a secondary cover 304. Optionally, the masking mold 300 can include raised portions 306 that creates a hole or a feature in the primary cover 302 or in the secondary cover 304 depending on the design of the backplate 106. The material used to make the primary cover 302 and the secondary cover 304 can be the same material or different materials, such as polymers, molded plastic, elastomers, resins, thermoplastics, thermosets, and the like. The mask may be made similar to ones discussed in U.S. Pat. No. 5,691,018 to Caterpillar. In another aspect of the disclosure, the primary cover 302 and secondary cover 304 can be made by 3D printing or any other process.

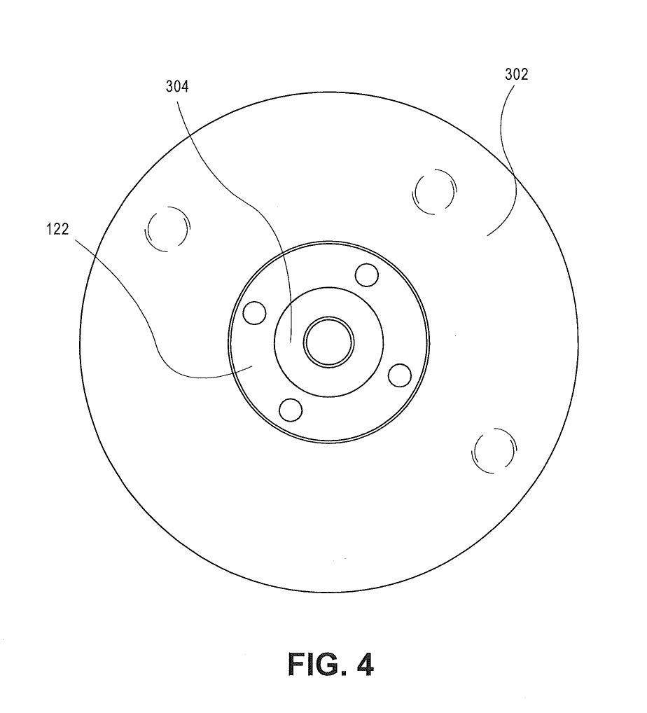

FIG. 4 illustrates a mask used in the remanufacturing process according to an aspect of the disclosure. As shown the primary cover 302 covers a large portion of backplate 106 and the secondary cover 304 covers a smaller portion of backplate 106 and leaving exposed the sealing surface 122 for the thermal metal spray.

FIG. 5 illustrates the remanufacturing process 400 according to an aspect of the disclosure. The process 400 starts at step 402. At step 404, clean component or the backplate 106 to remove any materials such as rust, oil, contaminants by using heat, sodium hydroxide, degreaser, alcohol and the like. At step 406, apply anti-bonding agent to the portions of backplate 106 to prevent the thermal metal spray from adhering thereto. That is, portions of the backplate other than the sealing surface 122 or the portions that would have been covered by the primary cover 302 and secondary cover 304 if applied to the backplate 106. The anti-bonding agent can be in the form of a paint or a tape and the like and the agent can be urethane based resin that requires curing or no curing. Depending on the anti-bonding agent chosen, the agent can be removed through heat, peeling or water soluble. Any type of anti-bonding agent can be used so long as the agent does not affect the work piece (backplate) in any away during use or during its removal from the surface of the work piece. Alternatively or in addition to, at step 408, apply the mask or the primary cover 302 and the secondary 304 to the portions of the backplate 106 as shown in FIG. 4. In this aspect, as an example, the primary cover 302 may be used to cover a portion of the backplate 106 and the anti-bonding agent can be used to cover the remaining portions of the backplate (where the secondary cover is used) that will not require the thermal metal spray. After step 406 or 408, the step proceeds to step 410 where the initial machining of the component is conducted to remove major defects in the backplate 106, such as scars, nicks, gouges and the like. The machining can be done with carbide inserts such as inserts DNMG 150404-PM 4225 or DNMG 431-PM 4225 from SANDVIK COROMANT. At step 412, a second cleaning of the component, such as light sanding, polishing and the like to remove any additional materials that may have flaked off during the machining step.

At step 414, apply thermal metal spray to the backplate 106. Any type of thermal metal spray process can be used such as combustion flame spraying, high velocity oxy-fuel spraying (HVOF), two-wire electric arc spraying, plasma spraying, or vacuum plasma spraying and the like. Further, in one aspect of the disclosure more than one of the thermal metal spray processes may be used in conjunction with each other depending on the conditions of the backplate 106. In combustion flame spraying, the flame is propelled by oxygen mixed with fuel, which also results in melting the metal mixture. The combustion flame spraying uses powder or wire as the main coating mixture component. HVOF is similar to combustion flame spraying, but uses a different torch design that enables the flame to expand when the spray nozzle is engaged. This causes a surge in acceleration, and when the mixture is released from the nozzle, the velocity of the mixture leads to an evenly thin coat. In two-wire electric arc spraying, the deposition relies on an arc-point formed by two electrically conductive wires. Where the wires meet, melting occurs. In plasma spraying, a plasma torch is the primary source of heating and applying the coating. Once the powdered material has been melted, it is subsequently applied to the product in a similar manner as combustion flame spraying. Vacuum plasma spraying is a low temperature method that must be conducted inside a controlled environment, which not only sustains the vacuum but also helps minimize damage to the material. Because the vacuum environment is controlled, it helps ensure a more precise application of the material. Any material that is wear resistant and having high hardness can be thermally sprayed including nickel, nickel based alloys (NiAl, NiCr), stainless steel, Molybdenum MCrAlY's (NiCrAlY, CoCrAlY, NiCoCrAlY, CoNiCrAlY), Titanium (Ti), Stellite, Triballoy and the like. In other aspects of the disclosure, ceramics may be alternatively used.

In one aspect, NiAl or a stainless steel can be used and sprayed onto the backplate for a number of cycles ranging from about 2-8 cycles, each cycle may include about 3-7 passes that applies about 0.050 μm to about 0.090 μm at about 40-70 psi. A robot arm can be used having a travel speed from about 20 mm/sec to about 40 mm/sec and having a standoff from the backplate during spraying from about 3-9 inches. A rotating table having the backplate 106 can rotate the backplate 106 between about 20 rpm to about 45 rpm. The operating voltage can be about 20-40 V and the current about 130-170 A depending on the spraying process used.

At step 416, a final machining of the component or the backplate 106 is conducted to ensure that the backplate is returned to the original manufacturer's specifications. The final machining can be done using any known method including sanding, milling and the like. It should be noted that the machining steps discussed herein can be done with operating parameters such as at ambient temperature between about 60-90° F., at rotational speed about 50-1300 rpm and at a feed rate of about 0.1-1.0 SFM. At step 418, detailing of the component of the backplate 106 to add or remove any remaining features such as part number, logo and the like. At step 420, the component or the backplate 106 is cleaned and polished to remove any residual sprayed materials or from the final machining step. At step 422, confirm that the component or the backplate 106 meets or exceeds the original manufacturer's specification so that it can then be ready to be used in the turbochargers. At step 424, the process ends.

The process described above can be used with any component in any vehicle, device, apparatus and the like that can be remanufactured. Further, the steps in the process do not all have to be performed or performed in any particular order. Some of the steps can be performed at the same time or be combined.

### INDUSTRIAL APPLICABILITY

A process of remanufacturing a backplate of turbochargers is provided. Portions of the backplate such as the sealing surface will wear out during use and needs to be returned to the original manufacturer specifications. The sealing surface can prevent any air leaks from the compressor portion of the turbocharger. A thermal metal spray can be used in the remanufacturing process. Any type of thermal spray metal techniques can be used such as combustion flame spraying, high velocity oxy-fuel spraying (HVOF), two-wire electric arc spraying, plasma spraying, and vacuum plasma spraying and the like. The process includes using a mask to cover portions of the backplate that does not need to be thermal metal spray. Alternatively or in addition to, an anti-bonding agent can be used on portions of the backplate that is not subjected to the thermal metal spray. Once the thermal metal spray is applied, additional cleaning and machining can be done to return the backplate to its original manufacturer's specification and for later use in repairs to the turbochargers.

We claim:

1. A method of remanufacturing a backplate of a turbocharger, comprising the steps of:
cleaning the backplate for a first time;
protecting a portion of the backplate, other than a sealing surface, from a thermal metal spray with a mask;
machining the backplate for a first time;
applying a metal to the sealing surface with a thermal metal spray; and
machining the backplate for a second time.

2. The method of claim 1 further comprising the step of cleaning the backplate for a second time.

3. The method of claim 1 further comprising the step of confirming that the backplate is within a manufacturer's original specifications.

4. The method of claim 1, wherein the thermal metal spray is one of the following: a combustion flame spraying, a high velocity oxy-fuel spraying (HVOF), a two-wire electric arc spraying, a plasma spraying, or a vacuum plasma spraying and the like.

5. The method of claim 1, wherein the thermal spray is a combination of more than one of the following: a combustion flame spraying, a high velocity oxy-fuel spraying (HVOF), a two-wire electric arc spraying, a plasma spraying, and a vacuum plasma spraying and the like.

6. The method of claim 1 further comprising the step of applying an anti-bonding agent to the same portion of the backplate as the mask.

7. The method of claim 1 further comprising the step of applying an anti-bonding agent to a different portion of the backplate than the mask.

8. The method of claim 1, wherein the metal used is a nickel based alloy.

9. The method of claim 7, wherein the anti-bonding agent is a resin paint.

10. The method of claim 1, wherein the mask is made from one of the following material: a polymer, a molded plastic, an elastomer, a resin, a thermoplastic, or a thermoset, and the like.

11. A method of remanufacturing a backplate of a turbocharger, comprising the steps of:
cleaning the backplate for a first time;
protecting a portion of the backplate, other than a sealing surface, from a thermal metal spray with an antibonding agent;
machining the backplate for a first time;
applying a metal to the sealing surface with a thermal metal spray; and
machining the backplate for a second time.

12. The method of claim 11 further comprising the step of cleaning the backplate for a second time.

13. The method of claim 11 further comprising the step of confirming that the backplate is within a manufacturer's original specifications.

14. The method of claim 11, wherein the thermal metal spray is one of the following: a combustion flame spraying, a high velocity oxy-fuel spraying (HVOF), a two-wire electric arc spraying, a plasma spraying, or a vacuum plasma spraying and the like.

15. The method of claim 11, wherein the thermal spray is a combination of more than one of the following: a combustion flame spraying, a high velocity oxy-fuel spraying (HVOF), a two-wire electric arc spraying, a plasma spraying, and a vacuum plasma spraying and the like.

16. The method of claim 11 further comprising the step of applying a mask to the same portion of the backplate as the anti-bonding agent.

17. The method of claim 11 further comprising the step of applying a polymer mask to a different portion of the backplate than the anti-bonding agent.

18. The method of claim 11, wherein the metal is a nickel based alloy.

19. The method of claim 11, wherein the anti-bonding agent is a resin paint.

20. The method of claim 16, wherein the mask is made from one of the following material: a polymer, a molded plastic, an elastomer, a resin, a thermoplastic, or a thermoset, and the like.
